(19) United States
(12) Patent Application Publication
(10) Pub. No.: US 2005/0207937 A1
(43) Pub. Date: Sep. 22, 2005

(54) Carriage direction switching apparatus for test-tube carrier path

(75) Inventor: Teruaki Itoh, Kumamoto-shi (JP)

Correspondence Address: NIXON & VANDERHYE, PC, 901 NORTH GLEBE ROAD, 11TH FLOOR, ARLINGTON, VA, 22203, US

(73) Assignee: IDS COMPANY, LTD., Kumamoto-shi (JP)

(21) Appl. No.: 11/080,533

(22) Filed: Mar. 16, 2005

(30) Foreign Application Priority Data
Mar. 22, 2004 (JP) 2004-083109

(51) Int. Cl. B01L 9/00; G01N 35/00

(52) U.S. Cl. 422/63; 422/104

(57) ABSTRACT

There is provided a carriage direction switching apparatus for a test-tube carriage path, which comprises a first carriage path including a connecting outlet, a second carriage path including a connecting inlet, a relay member interposed between the connecting outlet and the connecting inlet, and configured to guide, to the connecting inlet, an opening/closing arm opposing the connecting outlet, and a direction switching mechanism provided adjacent to the relay member. In particular, the direction switching member includes a rotary member located at a level at which the rotary member can attract the metal ring of the test-tube holder, a plurality of magnets embedded in the outer periphery of the rotary member, and a driving motor for continuously rotating the rotary member with the magnets.

### CROSS-REFERENCE TO RELATED APPLICATIONS

This application is based upon and claims the benefit of priority from prior Japanese Patent Application No. 2004-083109, filed Mar. 22, 2004, the entire contents of which are incorporated herein by reference.

### BACKGROUND OF THE INVENTION

1. Field of the Invention

The present invention relates to a carriage direction switching apparatus for switching a test-tube carrier path unit that includes a first carriage path for carrying, to a first process unit, test-tube holders holding test tubes with blood samples contained therein, and a second carriage path for switching the direction of carrying the test-tube holders to a second process unit.

2. Description of the Related Art

The carriage direction switching apparatus for a test-tube carrying path as shown in FIG. 5 is well known.

The carriage direction switching apparatus is used to carry test-tube holders 10 that hold test tubes P containing blood samples. The apparatus comprises a first carriage path 11, second carriage path 12, relay member 3, opening/closing arm 5, synchronous opening/closing arm 6 and direction switching mechanism 8.

The first carriage path 11 has a connecting outlet 1 for the test-tube holders 10 at its middle portion, and is arranged to carry each holder 10 toward a first process unit X while fixing it upright. The first process unit X is located downstream of the connecting outlet 1 with respect to the carriage direction.

The second carriage path 12 has, at its middle portion, a connecting inlet 2 facing the connecting outlet 1 with a predetermined distance therebetween. The second carriage path 12 is arranged to carry, to a second process unit Y, each test-tube holder 10 introduced through the connecting inlet 2, while fixing it upright.

The carriage direction of the second carriage path 12 is opposite to that of the first carriage path 11. The second process unit Y is located downstream of the connecting inlet 2 with respect to the carriage direction.

The first and second carriage paths 11 and 12 are located parallel to each other, with a predetermined space therebetween.

The relay member 3 connects the connecting outlet 1 to the connecting inlet 2. Further, the test-tube holders 10 introduced through the connecting outlet 1 are guided to the connecting inlet 2 so as not to fall.

The opening/closing arm 5 is provided along the first carriage path 11 and faces the connecting outlet 1 with the first carriage path 11 interposed therebetween. The opening/closing arm 5 is opened and closed by the operation of a cylinder 4.

Specifically, when each test-tube holder 10 is carried to the first process unit X, the opening/closing arm 5 is moved to a path-opening state as indicated by the imaginary line in FIG. 5, in which the arm 5 is radially retracted from the carriage path 11 to open it. As a result, each test-tube holder 10 is permitted to move to the first process unit X.

In contrast, when each test-tube holder 10 is carried to the second process unit Y by switching, the opening/closing arm 5 is set to a path-closing state as indicated by the solid line in FIG. 5, in which the arm 5 is radially protruded to the carriage path 11 to close it. As a result, each test-tube holder 10 is guided to the connecting outlet 1.

The synchronous opening/closing arm 6 is provided along the second carriage path 12 and faces the connecting inlet 2, and is arranged to be opened and closed by a cylinder 7 in synchronism with the operation of the opening/closing arm 5. When the synchronous opening/closing arm 6 is set to a path-closing state as indicated by the solid line in FIG. 5, in which the arm 6 is radially protruded to the carriage path 12 to close it, each test-tube holder 10 introduced through the connecting inlet 2 is guided to the width-directionally central portion of the second carriage path 12.

The direction switching mechanism 8 is located adjacent to the relay member 3, and is used to move each test-tube holder 10 introduced to the relay member 3, when the opening/closing arm 5 is set to the path-closing state. Namely, the mechanism 8 guides each test-tube holder 10 from the connecting outlet 1 to the connecting inlet 2, and then from the connecting inlet 2 to the second carriage path 12.

The direction switching mechanism 8 comprises a bar section 9 and driving motor M.

The bar section 9 is arranged to rotate on a horizontal plane to thereby guide each test-tube holder 10 from the connecting outlet 1 to the connecting inlet 2.

The driving motor M rotates the bar section 9 in the direction indicated by the arrow in FIG. 5 when the carriage direction of each test-tube holder 10 is switched.

However, the conventional direction switching mechanism 8 is constructed such that the bar section 9 has a length that makes the bar section 9 reach the width-directional central portion of each of the first and second carriage paths 11 and 12, as is indicated by the broken lines in FIG. 5.

Accordingly, if the retraction of the opening/closing arm 5 to the path-opening position is not synchronized with the stop of the driving motor M, the test-tube holder 10 being carried will be blocked by the bar section 9 and stopped. As a result, the bar section 9 stops its rotation in a state in which it protrudes to the carriage paths 11 and 12.

In contrast, if the bar section 9 is continuously rotated regardless of whether the opening/closing arm 5 operates, when the arm 5 is in the path-opening position (in which each test-tube holder 10 can be carried to the first process unit X), the bar section 9 collides with the test-tube holder 10 being carried. As a result, the test-tube holder 10 being carried may well be broken.

### BRIEF SUMMARY OF THE INVENTION

In accordance with an embodiment of the present invention, there is provided a carriage direction switching apparatus for a test-tube carriage path, comprising:
a first carriage path including a connecting outlet at a middle portion thereof, and configured to carry a test-tube holder in an upright state to a first process unit, the test-tube holder having a metal ring provided on a cylindrical portion incorporated in the test-tube holder;
a second carriage path including a connecting inlet facing the connecting outlet of the first carriage path with a predetermined distance interposed therebetween, the second carriage path being configured to carry, in the upright state to a second process unit, the test-tube holder introduced through the connecting inlet;
a relay member connecting the connecting outlet to the connecting inlet, and configured to guide, to the connecting inlet, the test-tube holder introduced through the connecting outlet, while preventing the test-tube holder from falling;
an opening/closing arm opposing the connecting outlet of the first carriage path, the opening/closing arm being radially retracted to a carriage-path-opening position to permit the test-tube holder to pass through the first carriage path, when the test-tube holder is carried to the first process unit, the opening/closing arm being radially protruded to a carriage-path-closing position to receive and guide the test-tube holder to the connecting inlet, when the test-tube holder is carried to the second process unit; and
a direction switching mechanism provided adjacent to the relay member, and configured to move the test-tube holder from the connecting outlet to the connecting inlet and then from the connecting inlet to the second carriage path,
wherein the direction switching mechanism includes:
a rotary member rotatable about a vertical axle and having a diameter which enables transfer of the test-tube holder from the connecting outlet to the connecting inlet, the rotary member being located at a level at which the rotary member can attract the metal ring of the test-tube holder;
a plurality of magnets embedded in an outer periphery of the rotary member at regular angular interval, the magnets being magnetically attached to the metal ring of the test-tube holder to move the test-tube holder; and
a driving motor configured to continuously rotate the rotary member with the magnets to move the test-tube holder from the connecting outlet to the connecting inlet.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a plan view illustrating a major part of a carriage direction switching apparatus for a test-tube carriage path unit according to a first embodiment of the invention;

FIG. 2 is an enlarged sectional view taken along line II-II′ of FIG. 1;

FIG. 3 is an enlarged sectional view taken along line III-III′ of FIG. 1;

FIG. 4 is a plan view illustrating a major part of a carriage direction switching apparatus for a test-tube carriage path unit according to a second embodiment of the invention; and

FIG. 5 is a plan view illustrating a major part of a conventional carriage direction switching apparatus for a test-tube carriage path unit.

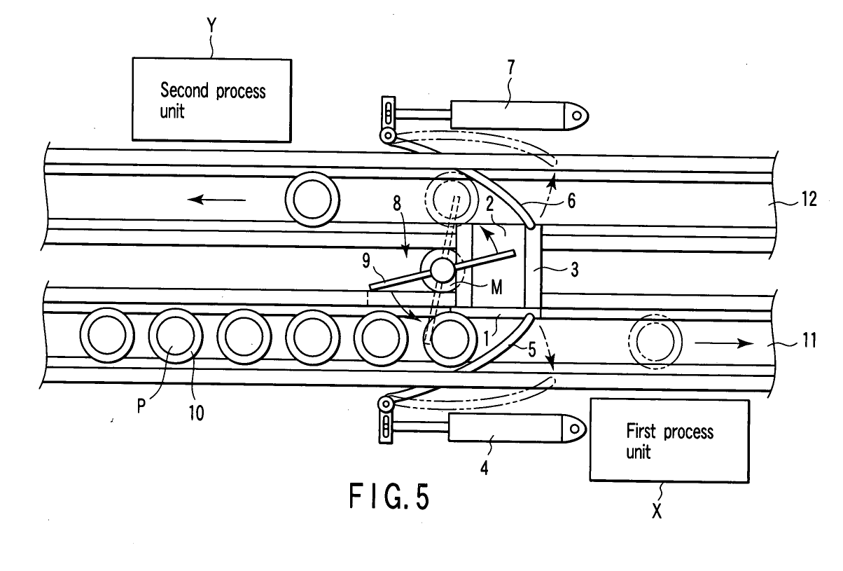

### DETAILED DESCRIPTION OF THE INVENTION

Embodiment of the invention will be described in detail with reference to the accompanying drawings.

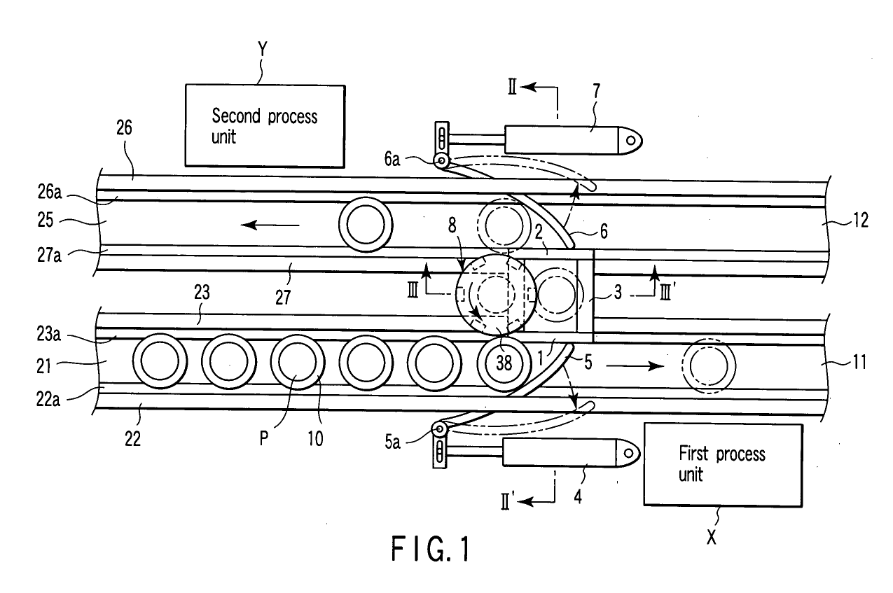

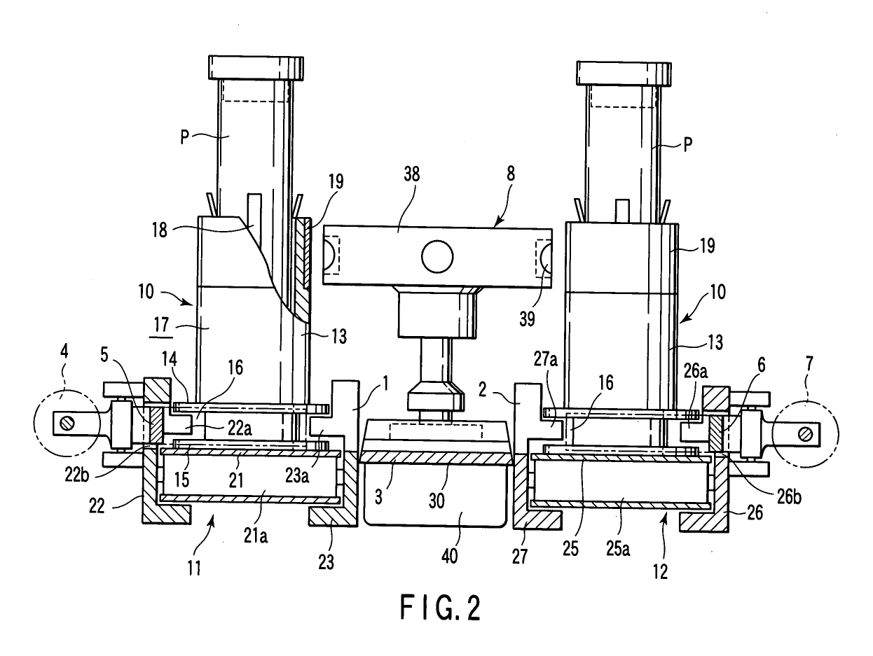

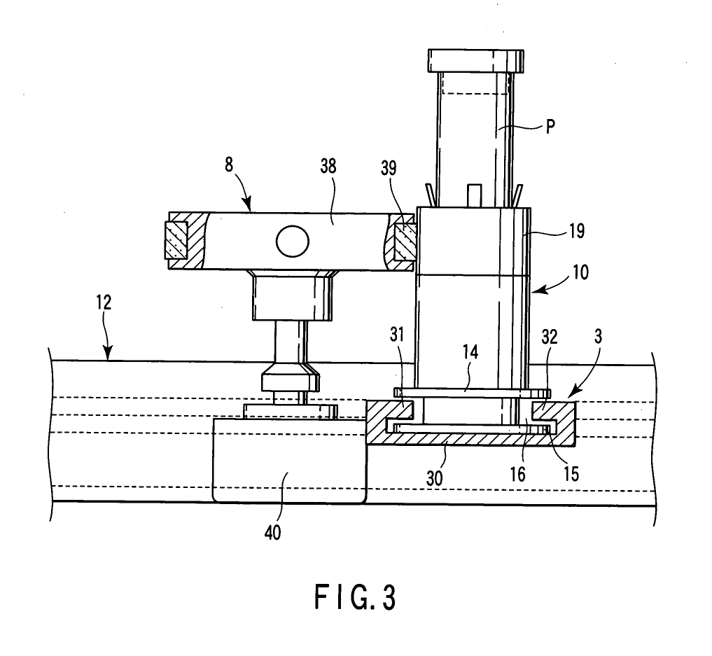

FIG. 1 is a plan view illustrating a major part of a carriage direction switching apparatus for a test-tube carriage path unit according to a first embodiment of the invention. FIG. 2 is an enlarged sectional view taken along line II-II′ of FIG. 1. FIG. 3 is an enlarged sectional view taken along line III-III′ of FIG. 1.

Test-tube holders 10 are holders to be carried. As clearly shown in FIG. 2, each test-tube holder 10 comprises a holder main unit 17, plate springs 18 and metal ring 19.

The holder main unit 17 is formed of a synthetic resin, and has a cylindrical section 13 whose bottom is closed, and a pair of flanges 14 and 15 and an annular groove 16 therebetween, which are provided on the periphery of the lower portion of the cylindrical section 13.

The plate springs 18 are provided in the cylindrical section 13 for holding a test tube P (containing a blood sample) inserted into the holder main unit 17 through the upper opening.

The metal ring 19 is fitted on the upper periphery of the cylindrical section 13.

A first carriage path 11 has a connecting outlet 1 for the test-tube holders 10 at its middle portion, and is arranged to carry each test-tube holder 10 toward a first process unit X while fixing it upright. The first process unit X is located downstream of the connecting outlet 1 with respect to the carriage direction.

The first carriage path 11 comprises a belt conveyer 21 and side frame members 22 and 23.

The belt conveyer 21 is driven by a roller 21a.

The side frame members 22 and 23 are provided at the opposite sides of the belt conveyer 21 with respect to the carriage direction. The frame members 22 and 23 have holder guide projections 22a and 23a to be engaged with the annular groove 16 of each test-tube holder 10 as shown in FIG. 2. Further, as shown in FIG. 2, the connecting outlet 1 is formed in the side frame member 23 by cutting a part thereof.

A second carriage path 12 has, at its middle portion, a connecting inlet 2 opposing the connecting outlet 1 with a predetermined distance therebetween. The second carriage path 12 is arranged to carry, to a second process unit Y, each test-tube holder 10 introduced through the connecting inlet 2, while fixing it upright.

The second carriage path 12 comprises a belt conveyer 25 and side frame members 26 and 27.

The belt conveyer 25 carries each test-tube holder 10 while fixing it upright. In accordance with the rotation of a roller 25a, the belt conveyer 25 rotates in the direction of carriage.

The side frame members 26 and 27 have holder guide projections 26a and 27a to be engaged with the annular groove 16 of each test-tube holder 10 as shown in FIG. 2. These frame members are provided at the opposite sides of the belt conveyer 25 with respect to the carriage direction. Further, as shown in FIG. 2, the connecting inlet 2 is formed in the side frame member 27 by cutting a part thereof.

The first and second carriage paths 11 and 12 are located parallel to each other, with a predetermined space therebetween. Further, the carriage direction of the second carriage path 12 is opposite to that of the first carriage path 11. Each test-tube holder 10 is carried to the second process unit Y located downstream of the connecting inlet 2 with respect to the carriage direction.

The relay member 3 connects the connecting outlet 1 to the connecting inlet 2 as shown in FIG. 2. The relay member 3 enables each test-tube holder 10 introduced through the connecting outlet 1 to be slid to the connecting inlet 2 in contact with it so that each test-tube holder 10 will not fall.

The relay member 3 comprises a plate member 30 and metal members.

The plate member 30 is brought into contact with the lower surface of each test-tube holder 10 when each holder 10 is guided. As shown in FIG. 2, the upper surface of the plate member 30 is substantially level with the upper surfaces of the belt conveyers 21 and 25.

The metal members are provided at the opposite sides of the plate member 30, and have a thin cross section. As can be seen from FIG. 3, the metal members have holder guide projections 31 and 32 to be engaged with the annular groove 16 of each test-tube holder 10.

An opening/closing arm 5 is provided opposing the connecting outlet 1 of the first carriage path 11, and is opened and closed (i.e., is made to pivot on an axle 5a) by the operation of a cylinder 4.

When each test-tube holder 10 is carried to the first process unit X, the opening/closing arm 5 is set to a path-opening state as indicated by the imaginary line in FIG. 1, in which the arm 5 is radially retracted from the carriage path 11 to open it. As a result, each test-tube holder 10 is permitted to move to the first process unit X.

In contrast, when each test-tube holder 10 is carried to the second process unit Y by switching, the opening/closing arm 5 is set to a path-closing state as indicated by the solid line in FIG. 1, in which the arm 5 is radially protruded to the carriage path 11 to close it. As a result, each test-tube holder 10 is guided to the connecting outlet 1.

The opening/closing arm 5 is formed of a gently curved member that is opened and closed through a laterally elongated hole 22b formed in the conveyer side frame member 22.

The synchronous opening/closing arm 6 is provided opposing the connecting inlet 2 of the second carriage path 12, and is opened and closed (i.e., is made to pivot on an axle 6a) by the operation of a cylinder 7 in synchronism with the operation of the opening/closing arm 5.

When the synchronous opening/closing arm 6 is in a path-closing state as indicated by the solid line in FIG. 1, in which the arm 6 is radially protruded to the carriage path 12 to close it, each test-tube holder 10 introduced through the connecting inlet 2 is guided to the conveyer of the second carriage path 12. Furthermore, in this state, the arm 6 temporarily receives and stops the test-tube holder (not shown) carried from upstream with respect to the carriage direction (i.e., from the right hand of the path-closing position of the arm 6 in FIG. 1).

The synchronous opening/closing arm 6 is formed of a gently curved member that is opened and closed through a laterally elongated hole 26b formed in the conveyer side frame member 26.

A direction switching mechanism 8 is provided adjacent to the relay member 3. This mechanism comprises a rotary member 38, magnets 39 and driving motor 40.

The rotary member 38 has a diameter that enables itself to transfer each test-tube holder 10 from the connecting outlet 1 to the connecting inlet 2. Further, the member 38 is rotatable about a vertical shaft at the level at which the magnets 39 are magnetically attached to the metal ring 19 of each test-tube holder 10, as shown in FIGS. 2 and 3.

The magnets 39 are embedded in the outer periphery of the rotary member 38 at regular angular intervals (in this embodiment, at intervals of 60°, i.e., six magnets 39 are provided). When each test-tube holder 10 passes through the connecting outlet 1, the six magnets 39 attract the metal ring 19 of each test-tube holder 10 as shown in FIG. 3, and move each holder when they are rotated together with the rotary member 38.

The driving motor 40 continuously radially moves the rotary member 38 with the magnets 39 to move each test-tube holder 10 from the connecting outlet 1 to the connecting inlet 2.

The rotary member 38 is in the shape of a disk, and has diametrically opposite side portions of the outer periphery positioned above the side frame members 23 and 27 of the first and second carriage paths 11 and 12 as shown in FIG. 2. However, note that the diameter of the rotary member 38 is designed so that the rotary member 38 does not contact each test-tube holder 10 carried over the first or second carriage path 11 or 12 even if it moves slightly in the width direction of the path 11 or 12.

As described above, the rotary member 38 is designed out of contact with each test-tube holder 10 carried over the path 11 or 12. Therefore, even if the rotary member 38 is continuously rotated, it is prevented from being brought into contact with each holder 10 (metal ring 19) carried over the first carriage path 11, regardless of the opening or closing state of the arm 5, when the arm 5 is in the retracted state as indicated by the imaginary line in FIG. 1 (i.e., when each test-tube holder 10 is carried toward the first process unit X). In other words, the test-tube holders 10 that are being carried toward the first process unit X are prevented from being wrongly guided to the connecting outlet 1 by the magnets 39 of the rotary member 38.

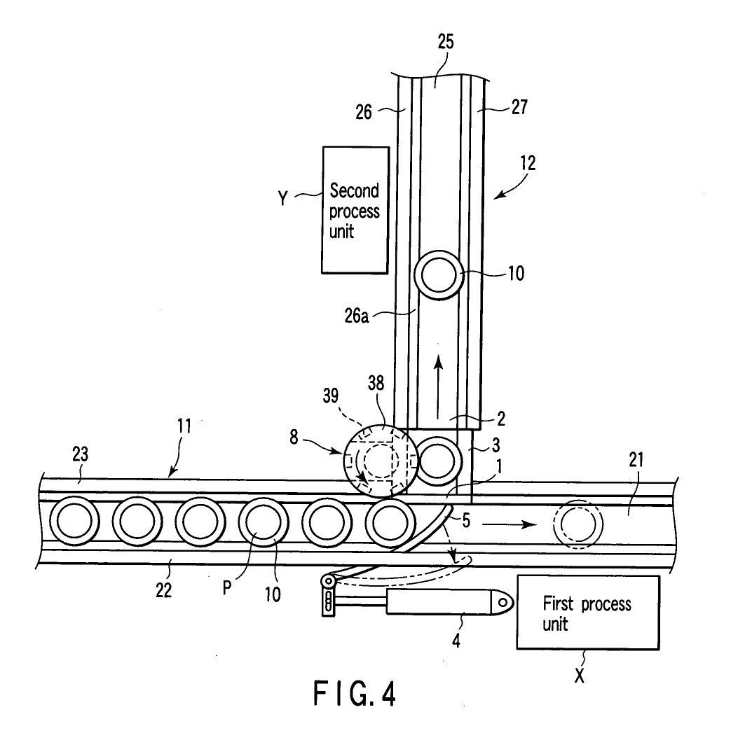

FIG. 4 shows a second embodiment of the invention.

The second embodiment differs from the first embodiment in that in the former, the second carriage path 12 is a branch carriage path perpendicular to the first carriage path 11 (alternatively, the path 12 may extend to form an acute angle to the path 11). In the second embodiment, the upstream end port of the branch carriage path with respect to the direction of carriage serves as the connecting inlet 2, and the relay member 3 is provided between this inlet and the connecting outlet 1 of the first carriage path 11.

The other structures of the second embodiment are similar to those of the first embodiment. In FIG. 4 directed to the second embodiment, elements similar to those of the first embodiment are denoted by corresponding reference numerals, and no detailed description will be given thereof.

Also in the above-mentioned structure, the direction switching mechanism 8 employs the rotary member 38 with the magnets 39 to be magnetically attached to the metal ring 19 of each test-tube holder 10 to rotate it. In this structure, while the rotary member 38 of the direction switching mechanism 8 is continuously rotated, the opening/closing arm 5 is opened and closed. Accordingly, each test-tube holder 10 can be reliably switched to a predetermined direction, with the result that jamming of test-tube holders 10 carried over a carriage path can be avoided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A carriage direction switching apparatus for a test-tube carriage path, comprising:
a first carriage path including a connecting outlet at a middle portion thereof, and configured to carry a test-tube holder to a first process unit, the test-tube holder having a metal ring provided on a cylindrical portion incorporated in the test-tube holder;
a second carriage path including a connecting inlet facing the connecting outlet of the first carriage path, the second carriage path being configured to carry, to a second process unit, the test-tube holder introduced through the connecting inlet;
a relay member connecting the connecting outlet to the connecting inlet, and configured to guide, to the connecting inlet, the test-tube holder introduced through the connecting outlet, while preventing the test-tube holder from falling;
an opening/closing arm opposing the connecting outlet of the first carriage path, the opening/closing arm being set to a carriage-path-opening state to permit the test-tube holder to pass through the first carriage path, when the test-tube holder is carried to the first process unit, the opening/closing arm being set to a carriage-path-closing state to receive and guide the test-tube holder to the connecting inlet, when the test-tube holder is carried to the second process unit; and
a direction switching mechanism provided adjacent to the relay member, and configured to move the test-tube holder from the connecting outlet to the connecting inlet and then from the connecting inlet to the second carriage path,
wherein the direction switching member includes:
a rotary member rotatable about a vertical axle and having a diameter which enables transfer of the test-tube holder from the connecting outlet to the connecting inlet, the rotary member being located at a height at which the rotary member can attract the metal ring of the test-tube holder;
a plurality of magnets embedded in an outer periphery of the rotary member; and
a driving motor configured to rotate the rotary member with the magnets to move the test-tube holder from the connecting outlet to the connecting inlet.

2. The carriage direction switching apparatus according to claim 1, wherein the second carriage path is a branch carriage path intersecting the first carriage path at right angles or at an acute angle, the branch carriage path having an upstream end port with respect to a direction of carriage, the upstream end port serving as the connecting inlet, the relay member being interposed between the upstream end port and the connecting outlet.

3. The carriage direction switching apparatus according to claim 1, wherein:
the first carriage path extends parallel to the second carriage path with a predetermined distance interposed therebetween;
a carriage direction of the second carriage path differs from a carriage direction of the first carriage path;
the relay member is interposed between the connecting outlet of the first carriage path and the connecting inlet of the second carriage path;
the opening/closing arm opposes the connecting outlet of the first carriage path, and a synchronous opening/closing arm is provided opposing the connecting inlet of the second carriage path, the synchronous opening/closing arm being opened and closed in synchronism with an opening/closing operation of the opening/closing arm, the synchronous opening/closing arm guiding the test-tube holder, introduced through the connecting inlet, to a width-directional center portion of the second carriage path when the synchronous opening/closing arm is radially protruded to a carriage-path-closing position; and
the rotary member with the magnets attracts and rotates the test-tube holder on the first carriage path, thereby guiding the test-tube holder to the second carriage path.

4. A carriage direction switching apparatus for a test-tube carriage path, comprising:
a first carriage path configured to carry a test-tube holder in a first direction;
a second carriage path configured to carry the test-tube holder in a second direction different from the first direction;
a relay carriage path connecting the first carriage path to the second carriage path, and configured to carry the test-tube holder, introduced;
through a first connecting section connected to the first carriage path, to a second connecting section connected to the second carriage path;
an opening/closing arm facing the first connecting section connected to the first carriage path, and when the test-tube holder is carried from the first carriage path to the second carriage path, the opening/closing arm receiving the test-tube holder carried on the first carriage path, and guiding the received test-tube holder to the first connecting section; and
a rotary member with magnets adjacent to the relay carriage path, and configured to magnetically attract, using the magnets, a metal ring incorporated in the test-tube holder received by the opening/closing arm, thereby moving the test-tube holder in accordance with rotation of the magnets along with the rotary member.
